(19) United States
(12) Patent Application Publication
(10) Pub. No.: US 2026/0203720 A1
(43) Pub. Date: Jul. 16, 2026

(54) SYSTEMS AND METHODS FOR PREDICTIVE VEHICLE REPAIR

(71) Applicant: Ford Global Technologies, LLC, Dearborn, MI (US)

(72) Inventors: Joel Thompson, Detroit, MI (US); Seonghoon Kim, Ann Arbor, MI (US); Mackenzie Francisco, Detroit, MI (US); Ancilia Dmello, Novi, MI (US); Annemarie Shorter, Plymouth, MI (US)

(73) Assignee: Ford Global Technologies, LLC, Dearborn, MI (US)

(21) Appl. No.: 19/016,739

(22) Filed: Jan. 10, 2025

(51) Int. Cl. G06Q 10/20; G07C 5/00; G07C 5/08; G10L 15/26

(52) U.S. Cl. CPC G06Q 10/20; G07C 5/008; G07C 5/0808; G10L 15/26

(57) ABSTRACT

A vehicle repair intelligence system including a transceiver, a memory and a processor is disclosed. The transceiver may receive vehicle information and user inputs associated with the repair of a vehicle. The memory may store a trained machine model that may be trained using a training data. The processor may obtain a trigger signal, and then obtain the vehicle information and the user inputs associated with the repair of the vehicle responsive to obtaining the trigger signal. The processor may further identify a vehicle part to be replaced in the vehicle based on the vehicle information and the user inputs by executing instructions stored in the trained machine model. The processor may additionally transmit an order form associated with the vehicle part to a vehicle part supplier to ship the vehicle part to a vehicle service center.

### FIELD

The present disclosure relates to systems and methods for predicting one or more vehicle parts for replacement in a vehicle and shipping the vehicle parts to a vehicle service center before a vehicle repair appointment.

### BACKGROUND

When conducting maintenance and servicing, a vehicle owner typically takes the vehicle to a vehicle service center or a servicing station to get the vehicle serviced. When the vehicle reaches the vehicle service center, a technician at the vehicle service center may examine the vehicle and then commence with the vehicle service. The technician may have to replace one or more vehicle parts during the vehicle service.

There may be instances where the vehicle service center may not have the vehicle part for replacement in its inventory. In such cases, the vehicle owner may have to wait before the vehicle part is procured by the vehicle service center.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example process of training a trained machine module in accordance with the present disclosure.

FIG. 3 depicts an example process of predicting vehicle parts to be replaced in a vehicle and shipping the vehicle parts in accordance with the present disclosure.

FIG. 4 depicts a flow diagram of an example vehicle repair intelligence method in accordance with the present disclosure.

### DETAILED DESCRIPTION

### Overview

The present disclosure describes a system and method for predicting one or more vehicle parts that may need replacement in a vehicle when the vehicle may get repaired at a vehicle service center and ordering the vehicle parts well in advance of the vehicle's scheduled appointment at the vehicle service center so that the vehicle's waiting time at the vehicle service center is reduced. The system may be hosted on a server or a distributed computing system and may be an Artificial Intelligence/Machine Learning (AI/ML) based system that automatically “predicts” the vehicle parts that may need replacement in the vehicle based on vehicle details, diagnostic trouble codes (DTCs), and user inputs/comments associated with one or more issues associated with the vehicle.

In some aspects, the system may obtain a trigger signal from a computing system associated with the vehicle service center when the vehicle owner (or “user”) schedules a vehicle repair appointment for the vehicle at the vehicle service center. Responsive to obtaining the trigger signal, the system may obtain the vehicle details, DTCs for a predefined historical time duration (e.g., past 30 days) and the user inputs/comments associated with one or more issues associated with the vehicle. The vehicle details may be, for example, a vehicle model, a model year, a time in service, an engine type, a transmission type, a mileage, and/or the like associated with the vehicle that the system may obtain from a server or directly from the vehicle. Further, the system may obtain the DTCs for the predefined historical time duration directly from the vehicle. In some aspects, the user inputs/comments may be a transcript of a user conversation with an operator associated with the vehicle service center when the user contacts the vehicle service center operator to schedule the vehicle repair appointment. In other aspects, the user inputs/comments may be notes that the vehicle service center operator takes while conversing with the user. The system may obtain the user inputs/comments from the computing system associated with the vehicle service center.

Responsive to obtaining the vehicle details, the DTCs and the user inputs/comments as described above, the system may execute instructions stored in a trained machine module to predict one or more vehicle parts that may need replacement in the vehicle during the vehicle repair process, based on the obtained vehicle details, DTCs and user inputs/comments. In some aspects, the trained machine module may be trained using a training data that includes a mapping between vehicle details, DTCs and user inputs associated with a plurality of vehicles that have historically availed repair services and vehicle part information (e.g., vehicle service part numbers) associated with a plurality of vehicle parts that were replaced in the plurality of vehicles during the repair services.

Responsive to predicting the vehicle parts that may need replacement, the system may transmit a query to the computing system associated with the vehicle service center to check an availability status of the predicted vehicle parts in the vehicle service center inventory. The system may generate and transmit an order form associated with the predicted vehicle parts (and one or more auxiliary vehicle parts associated with the predicted vehicle parts) to a vehicle part supplier if the predicted vehicle parts are not available in the vehicle service center inventory. Responsive to receiving the order form, the vehicle part supplier may ship the vehicle parts (and the auxiliary vehicle parts) to the vehicle service center.

In some aspects, the system may transmit the order form to the vehicle part supplier a predefined time duration (e.g., 2-5 days) before the vehicle repair appointment so that the vehicle parts arrive at the vehicle service center before or at vehicle repair appointment time. In this manner, when the vehicle arrives at the vehicle service center for repair, the vehicle service center may already have the vehicle parts that may be needed in the vehicle, and hence the vehicle waiting time at the vehicle service center may be reduced. This significantly enhances user convenience and experience of getting the vehicle serviced/repaired and ensures that the vehicle becomes available for the user within a short time duration.

The present disclosure discloses a system and method that predicts and pre-orders one or more vehicle parts that may need replacement in a vehicle when the vehicle gets repaired, so that the vehicle's waiting time at the vehicle service center is reduced. The system uses AI to predict the vehicle parts for replacement and results in minimal human involvement. The system further checks the vehicle service center's inventory before placing an order for the vehicle parts, thereby optimizing inventory management at the vehicle service center and ensuring that the vehicle parts are not unnecessarily ordered.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

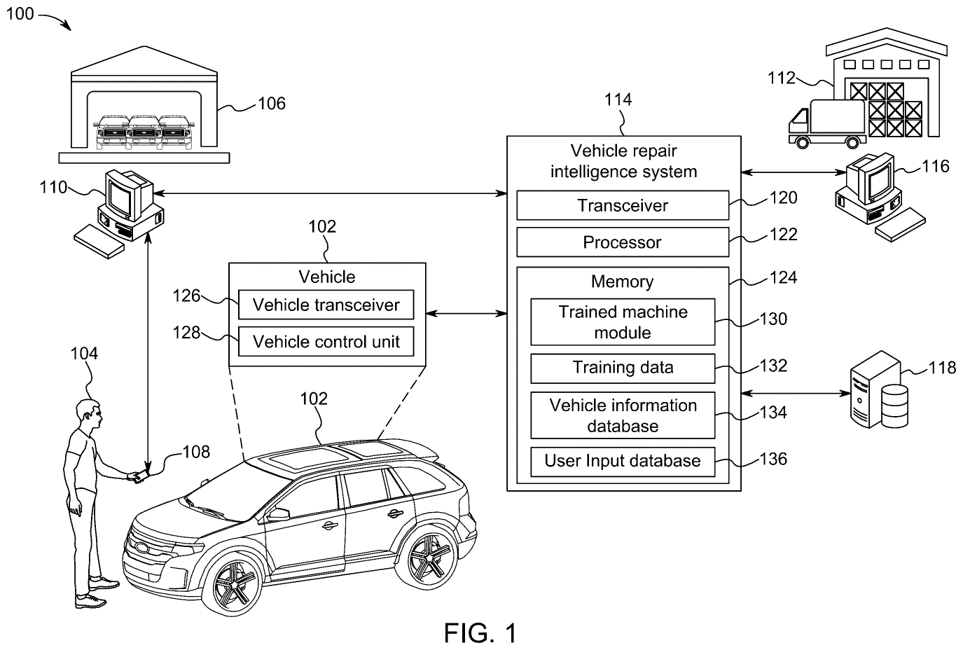

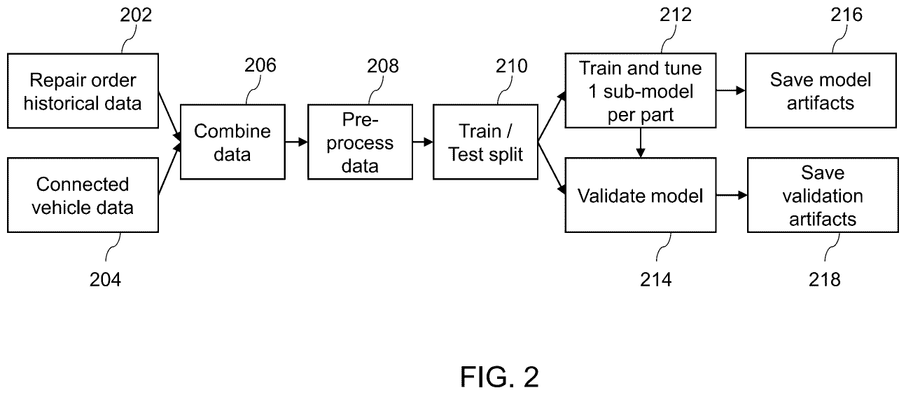

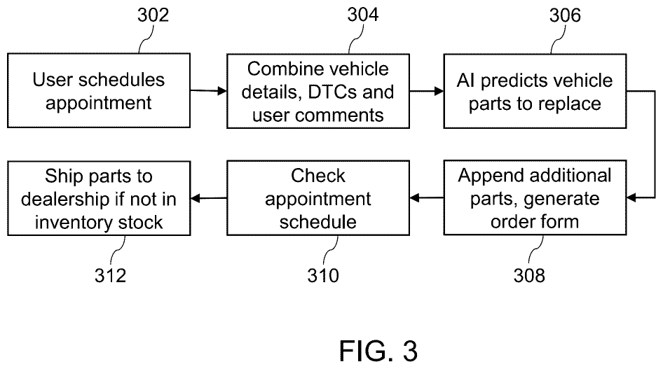

FIG. 1 depicts an example environment 100 in which techniques and structures for providing the systems and methods disclosed herein may be implemented. FIG. 1 will be described in conjunction with FIGS. 2 and 3.

The environment 100 may include a vehicle 102 and a user 104 who may be, for example, the owner of the vehicle 102. The vehicle 102 may take the form of any passenger or commercial vehicle, for example, a car, a work vehicle, a crossover vehicle, a truck, a van, a minivan, a taxi, a bus, etc. The vehicle 102 may be a manually driven vehicle and/or may be configured to operate in a partially or fully autonomous mode and may include any powertrain such as a gasoline engine, one or more electrically-actuated motor(s), a hybrid system, etc.

In some aspects, the vehicle 102 may need servicing or repair. To get the vehicle 102 serviced, the user 104 may schedule a vehicle service/repair appointment with a vehicle service center 106. In an exemplary aspect, the user 104 may schedule the vehicle repair appointment via a user device 108 and a computing system 110 associated with the vehicle service center 106. The user device 108 and/or the computing system 110 may be a mobile phone, a laptop, a computer, a smartwatch, or any other device with communication capability. The user 104 may contact and speak with an operator (or an automated chat bot) associated with the vehicle service center 106 to schedule the vehicle repair appointment via the user device 108 and the computing system 110.

It may be appreciated that when the vehicle service center 106 services or repairs the vehicle 102, there may be instances where the vehicle 102 may need replacement of one or more vehicle parts. For example, the vehicle 102 may need a replacement of the windshield during the vehicle repair process. Similarly, the vehicle 102 may need replacement of vehicle cameras, mirrors, sitting area equipment, engine parts, and/or the like.

While the vehicle 102 is getting serviced at the vehicle service center 106, the vehicle service center 106 may have to order one or more vehicle parts to be replaced from a vehicle part supplier 112 if such parts are not available in the vehicle service center's inventory. For example, if the technician believes that the vehicle's windshield needs to be replaced and a new windshield for the vehicle 102 model is not available in the vehicle service center's inventory, the vehicle service center 106 may have to order a new windshield from the vehicle part supplier 112. It may take days (or even weeks) before the new windshield reaches the vehicle service center 106 from the vehicle part supplier 112. Such a delay may cause inconvenience to the user 104 and may even render the vehicle 102 unavailable to the user.

To prevent such scenarios from happening, the present disclosure discloses a vehicle repair intelligence system 114 (or system 114, which may be part of the environment 100) that may “predict” beforehand the vehicle part(s) that the vehicle 102 may need for replacement and pre-order the vehicle parts from the vehicle part supplier 112 on behalf of the vehicle service center 106 if such vehicle parts are not available in the vehicle service center's inventory so that the needed vehicle parts reach the vehicle service center 106 by the time of the vehicle's repair appointment. The system 114 may be hosted on a server or a distributed computing system and may be an Artificial Intelligence (AI)/Machine Learning (ML) based system that predicts the vehicle part(s) for replacement based on vehicle information associated with the vehicle 102 and user inputs derived from the conversation between the user 104 and the vehicle service center's operator at the time of scheduling the vehicle repair appointment. Responsive to predicting the vehicle parts for replacement, the system 114 may automatically order the vehicle parts from the vehicle part supplier 112 and cause the vehicle part supplier 112 to ship the vehicle parts to the vehicle service center 106, so that the vehicle parts reach the vehicle service center 106 before or at the time of the vehicle repair appointment. This may reduce the vehicle's waiting time at the vehicle service center 106 during the vehicle repair process and may thus enhance user convenience and experience of getting the vehicle 102 serviced/repaired at the vehicle service center 106. The example process implemented by the system 114 to predict and pre-order the vehicle parts for replacement is described later in the description below.

The system 114 may be communicatively coupled with the vehicle 102, the user device 108, the computing system 110, a computing system 116 associated with the vehicle part supplier 112, an external server 118 (or server 118), and/or the like, via one or more network(s). The network(s), as described here, may be and/or include the Internet, a private network, public network or other configuration that operates using any one or more known communication protocols such as transmission control protocol/Internet protocol (TCP/IP), Bluetooth®, BLE, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The computing system 116 may be similar to the user device 108 and/or the computing system 110. The server 118 may be part of a cloud-based computing infrastructure and may be associated with and/or include a Telematics Service Delivery Network (SDN) that provides digital data services to the vehicle 102 and other vehicles (not shown in FIG. 1) that may be part of a vehicle fleet. In further aspects, the server 118 may receive (from the vehicle 102) and store vehicle information associated with the vehicle 102. In an exemplary aspect, the vehicle information may include diagnostic trouble codes (DTCs) associated with the vehicle 102. In further aspects, the vehicle information may include vehicle details such as a vehicle model, a model year, a time in service, an engine type, a transmission type, a mileage, and/or the like. The server 118 may transmit the vehicle information to the system 114 at a predefined frequency, or when the system 114 transmits a request to the server 118 to obtain such information.

The system 114 may include a plurality of units/components including, but not limited to, a transceiver 120, a processor 122 and a memory 124. The transceiver 120 may receive/transmit data/information/signals from/to external systems and devices via the network(s). For example, the transceiver 120 may receive the vehicle information described above from the server 118 (that may be a server or a database associated with a vehicle manufacturer) and/or a vehicle transceiver 126 associated with the vehicle 102. In an exemplary aspect, the vehicle 102 may include a vehicle control unit 128 that may determine the DTCs associated with the vehicle 102 and may transmit the DTCs to the vehicle transceiver 126, which may further transmit the DTCs to the transceiver 120. The vehicle 102 may further include a vehicle memory (not shown) that may store additional vehicle information/details such as the vehicle model, the model year, the time in service, the engine type, the transmission type, the mileage, and/or the like. The vehicle transceiver 126 may transmit such additional vehicle information to the transceiver 120 when the system 114 transmits a request to the vehicle 102 to obtain such information. In other aspects, the system 114 may receive the mileage information from the vehicle 102 (or the vehicle memory), and may receive the remaining vehicle information from the server 118.

A person ordinarily skilled in the art may appreciate that the vehicle 102 may include a plurality of additional units/components that are not shown in FIG. 1 and not described in the present disclosure. The vehicle units/components depicted in FIG. 1 are for illustrative purpose and should not be construed as limiting. The vehicle 102 may include additional units/components, without departing from the present disclosure scope.

The transceiver 120 may further receive user inputs associated with the repair/service of the vehicle 102 from the computing system 110 and/or the user device 108. In some aspects, the user inputs may include a transcript of a conversation between the user 104 and the operator associated with the vehicle service center 106 when the user 104 schedules the vehicle repair appointment for the vehicle 102. In an exemplary aspect, the user 104 may explain to the operator one or more issues associated with the vehicle 102 (e.g., broken windshield) that the user 104 may desire to get fixed/repaired during the vehicle servicing process at the vehicle service center 106. The user inputs may include information associated with such vehicle issues that may be discussed between the user 104 and the vehicle service center operator, when the user 104 contacts the vehicle service center operator to schedule the vehicle repair appointment. In additional or alternative aspects, the user inputs may be notes that the vehicle service center operator (who may be a human or an automated chat bot) may take when the user 104 explains the vehicle issues to the vehicle service center operator at the time of scheduling the vehicle repair appointment.

The transceiver 120 may be further configured to transmit signals, commands, and/or order forms to the computing system 116, which may enable the vehicle part supplier 112 to ship one or more vehicle parts to the vehicle service center 106.

The processor 122 may be an AI/ML based processor that may be disposed in communication with one or more memory devices disposed in communication with the respective computing systems (e.g., the memory 124 and/or one or more external databases not shown in FIG. 1). The processor 122 may utilize the memory 124 to store programs in code and/or to store data for performing aspects in accordance with the disclosure. The memory 124 may be a non-transitory computer-readable storage medium or memory storing program codes that may enable the processor 122 to perform operations as per the present disclosure. The memory 124 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 124 may include a plurality of databases and modules including, but not limited to, a trained machine module 130, a training data 132, a vehicle information database 134 and a user input database 136. The vehicle information database 134 may store the vehicle information described above that the system 114 may receive from the server 118 and/or directly from the vehicle 102. The user input database 136 may store the user inputs described above that the system 114 may receive from the computing system 110 and/or the user device 108.

In some aspects, the trained machine module 130 may be stored as computer executable instructions in the memory 124 and may be trained (e.g., by using supervised machine learning technique/algorithm) using the training data 132. In some aspects, as shown in FIG. 1, the training data 132 may be stored in the memory 124. In other aspects (not shown), the training data 132 may be stored in an external database (e.g., the server 118) that may be communicatively coupled with the system 114. In some aspects, the training data 132 may include a mapping between vehicle information and user inputs associated with a plurality of vehicles that have historically availed repair services and vehicle part information (e.g., vehicle part numbers) associated with a plurality of vehicle parts that were replaced in the plurality of vehicles during the repair services. For example, the training data 132 may include a mapping that indicates that a vehicle part “A” was replaced in a Vehicle “B” (not shown) two months back, and the corresponding vehicle information (e.g., DTCs, vehicle model, engine type, transmission type, etc. associated with Vehicle “B”) and the user inputs captured at the time of Vehicle B's repair appointment. The training data 132 may include such information associated with hundreds or thousands of vehicles that may have undergone repair/servicing historically.

In an exemplary aspect, the processor 122 may train the trained machine module 130 by using the training data 132 described above. The processor 122 may train the trained machine module 130 by using supervised machine learning technique. The trained machine module 130 may be configured to predict and output a part number (e.g., a base part number) associated with a vehicle part that may need replacement in a vehicle (e.g., the vehicle 102), when the vehicle information and the user inputs associated with the vehicle 102 are input to the trained machine module 130.

A person ordinarily skilled in the art may appreciate that machine learning is an application of Artificial Intelligence (AI) using which systems or processors (e.g., the processor 122) may have the ability to automatically learn and enhance from experience without being explicitly programmed. Machine learning focuses on the use of data and algorithms to imitate the way humans learn. In some aspects, the machine learning algorithms may be created to make classifications and/or predictions. Machine learning based systems may be used for a variety of applications including, but not limited to, speech recognition, image or video processing, statistical analysis, natural language processing, content generation, outcome prediction (e.g., prediction of vehicle parts that may need replacement), and/or the like.

Machine learning may be of various types based on data or signals available to the learning system. For example, the machine learning approach may include supervised learning, unsupervised learning, semi-supervised learning, or reinforcement learning. The supervised learning is an approach that may be supervised by a human. In this approach, the machine learning algorithm may use labeled training data and defined variables. In the case of supervised learning, both the input and the output of the algorithm may be specified/defined, and the algorithms may be trained to classify data and/or predict outcomes accurately.

Broadly, the supervised learning may be of two types, “regression” and “classification”. In classification learning, the learning algorithm may help in dividing the dataset into classes based on different parameters. In this case, a computer program may be trained on the training dataset and based on the training, the computer program may categorize input data into different classes. Some known methods used in classification learning include Logistic Regression, K-Nearest Neighbors, Support Vector Machines (SVM), Kernel SVM, Naïve Bayes, Decision Tree Classification, and Random Forest Classification. In some aspects, the trained machine module 130 may be trained by using classification type supervised learning.

In regression learning, the learning algorithm may predict output value that may be of continuous nature or real value. Some known methods used in regression learning include Simple Linear Regression, Multiple Linear Regression, Polynomial Regression, Support Vector Regression, Decision Tree Regression, and Random Forest Regression.

The unsupervised learning is an approach that involves algorithms that may be trained on unlabeled data. An unsupervised learning algorithm may analyze the data on its own and find patterns in input data. Further, semi-supervised learning is a combination of supervised learning and unsupervised learning. A semi-supervised learning algorithm involves labeled training data; however, the semi-supervised learning algorithm may still find patterns in the input data. Reinforcement learning is a multi-step or dynamic process. This model is similar to supervised learning but may not be trained using sample data. This model may learn “as it goes” by using trial and error. A sequence of successful outcomes may be reinforced to develop the best recommendation or policy for a given issue in reinforcement learning.

As described above, the processor 122 may train the trained machine module 130 by using supervised machine learning approach. The trained machine module 130 may be updated (or enhanced) as more training data may be fed to the processor 122. An example process implemented by the processor 122 to train the trained machine module 130 is depicted in FIG. 2 and described below.

The processor 122 may first obtain repair order historical data 202 and connected vehicle data 204 associated with a plurality of vehicles that may have undergone vehicle service/repair in the past (e.g., data for the past 5-6 years or more). In some aspects, the processor 122 may obtain the repair order historical data 202 from computing systems (e.g., the computing system 110) associated with a plurality of vehicle service centers (e.g., the vehicle service center 106) that may have serviced/repaired the plurality of vehicles described above. The repair order historical data 202 may include information associated with the vehicle model, model year, time in service, engine type, transmission type, the part numbers of the vehicle parts that were replaced during the vehicle service/repair process, user inputs or comments provided by vehicle owners while scheduling the repair appointments, and/or the like, associated with each of the plurality of vehicles. In one exemplary aspect, to ease the computational load, the processor 122 may obtain only the base part numbers (as opposed to the full part numbers) of the vehicle parts that were replaced during the vehicle service/repair process. In other aspects, the processor 122 may obtain the full part numbers of the vehicle parts that were replaced during the vehicle service/repair process.

Further, the processor 122 may obtain the connected vehicle data 204 from the server 118 (or directly from the vehicles) that may maintain a log of connected vehicle data 204 for each of the plurality of vehicles. The connected vehicle data 204 may include data associated with DTCs, mileage, etc., associated with each of the plurality of vehicles. In some aspects, the processor 122 may obtain the DTCs for only a predefined time duration (e.g., 15 days, 30 days, 45 days, etc.) before the respective vehicle repair appointment, for each of the plurality of vehicles. Further, in an exemplary aspect, to ease the computational load, the processor 122 may obtain only base DTCs (as opposed to full DTCs). In other aspects, the processor 122 may obtain full/entire DTCs.

Responsive to obtaining the repair order historical data 202 and the connected vehicle data 204 as described above, the processor 122 may combine the obtained data, shown by a block 206 in FIG. 2. Thereafter, the processor 122 may pre-process the combined data, shown by a block 208 in FIG. 2. The processor 122 may implement one or more different methods to pre-process the combined data. For example, the processor 122 may “reduce” the data size by reducing full DTCs to “core” DTCs, only focus on predicting base part number for vehicle parts that need replacement, only focus on top 30, 40 or 50 vehicle parts (by replacement count or by part model performance) for prediction, and/or the like. In some aspects, the processor 122 may focus on only those “top” performing vehicle parts that have historically performed stably and without any major issues in vehicles. As another example of pre-processing, the processor 122 may down-sample the data by re-balancing the distribution, encode the data, and/or perform similar actions to pre-process the combined data. In some aspects, the pre-processed data may form the training data 132 described above.

Responsive to pre-processing the combined data as described above, the processor 122 may split the data for training and testing, shown by a block 210 in FIG. 2. As an example, the processor 122 may split the data such that 10-15% of the data set can be used for validation and the remaining 85-90% of the data set can be used for training one or more machine learning modules. In some aspects, the processor 122 may perform a chronological split or timestamp split at the step associated with the block 210 described above.

The processor 122 may then train and tune (shown by a block 212 in FIG. 2) one sub-model (or one sub-trained machine module) for each vehicle part (e.g., for the top 30-50 vehicle parts by model performance) by using the data split (or earmarked) for training the machine learning modules. The processor 122 may further validate the trained module (shown by a block 214 in FIG. 2) by using the data split (or earmarked) for validation. The processor 122 may additionally store (in the memory 124) the model artifacts/details and the validation artifacts/details, shown by blocks 216 and 218 in FIG. 2. In some aspects, the processor 122 may additionally custom down-sample and/or tune other hyper-parameters of the sub-trained machine modules, to enhance the module's performance.

In some aspects, the stored model artifacts for all the sub-trained machine modules may collectively form the trained machine module 130. The processor 122 may update (or “re-train”) each sub-trained machine module (and hence the trained machine module 130) regularly as new training data is obtained by the processor 122 and/or based on outcomes from the validation exercise.

An example process implemented by the processor 122 and the trained machine module 130 to predict, in real-time, the vehicle part(s) that a vehicle (e.g., the vehicle 102) may need during the vehicle repair process at the vehicle service center 106 is depicted in FIG. 3 and described below.

In operation, the user 104 may schedule a vehicle repair appointment for the vehicle 102 at the vehicle service center 106 when the user 104 desires to get the vehicle 102 serviced/repaired, as shown by a block 302 in FIG. 3. In an exemplary aspect, the user 104 may use the user device 108 to contact the vehicle service center 106 (specifically contact the computing system 110) and schedule the vehicle repair appointment. The user 104 may schedule the vehicle repair appointment for a predefined future time and explain the issues (if any) experienced by the vehicle 102 to the vehicle service center operator. The computing system 110 may record the issues explained by the user 104 to the vehicle service center operator or the notes taken by the vehicle service center operator while conversing with the user 104 as “user inputs”. In some aspects, the user inputs may be a transcript of the user conversation with the vehicle service center operator or the notes taken by the vehicle service center operator.

The computing system 110 may further transmit a trigger signal to the transceiver 120 when the user 104 schedules the vehicle repair appointment at the vehicle service center 106. The transceiver 120 may then transmit the trigger signal to the processor 122. In this manner, the processor 122 may obtain the trigger signal when the user 104 schedules the vehicle repair appointment at the vehicle service center 106. Responsive to obtaining the trigger signal, the processor 122 may obtain (via the transceiver 120) the vehicle information associated with the vehicle 102 and the user inputs/comments associated with the vehicle 102 repair. As described above, the vehicle information may include DTCs of the vehicle 102 for a predefined historical time duration (e.g., for past 30 days) that the processor 122 may obtain from the server 118 or directly from the vehicle 102. The vehicle information may further include vehicle details such as the vehicle model, the model year, a time in service, the engine type, the transmission type, mileage, and/or the like associated with the vehicle 102, which the processor 122 may obtain from the vehicle 102 (or the server 118).

Responsive to obtaining the vehicle details, the DTCs and the user inputs/comments as described above, the processor 122 may combine the obtained details/inputs/information, as shown by a block 304 in FIG. 3. The processor 122 may then execute the instructions stored in the trained machine module 130 to identify one or more vehicle part(s) that may need to be replaced in the vehicle 102, based on the obtained vehicle details, DTCs and the user inputs. Stated another way, in this case, the AI trained machine module 130 may identify, based on the obtained information described above, the vehicle part(s) that may be needed to be replaced in the vehicle 102 when the vehicle 102 may get repaired in the vehicle service center 106 at the vehicle repair appointment time, as shown by a block 306 in FIG. 3. For example, if the user inputs indicate that the user 104 communicated to the vehicle service center operator that the vehicle windshield may need replaced, the trained machine module 130 or the processor 122 may identify “windshield” as the vehicle part to be replaced.

In some aspects, “predicting” the vehicle part, as described above, may mean predicting the part number of the vehicle part that may need to be replaced in the vehicle 102 during the vehicle repair/servicing process. Stated another way, the trained machine module 130 or the processor 122 predicts the part number of the vehicle part that may need to be replaced in the vehicle 102 (as opposed to predicting the vehicle part name). In some aspects, the processor 122 may predict only the base number of the vehicle part by using the instructions stored in the trained machine module 130 and may estimate the entire part number of the vehicle part by using the predicted base part number and the vehicle information (e.g., the vehicle model information or vehicle identification/VIN), e.g., by using a lookup table stored in the memory 124.

Responsive to predicting/identifying the vehicle part(s) that may need to be replaced in the vehicle 102 at the vehicle service center 106 during the vehicle repair appointment, the processor 122 may identify one or more auxiliary or additional vehicle parts needed to repair the vehicle 102 based on the predicted vehicle part and the obtained vehicle information. For example, if the predicted vehicle part is windshield, the processor 122 may identify one or more auxiliary vehicle parts that the vehicle service center 106 may need to install the new windshield in the vehicle 102 during the vehicle repair process, based on the vehicle details (e.g., model number, model year, etc.) associated with the vehicle 102.

The processor 122 may then transmit a query to the computing system 110 to check an availability status of the predicted vehicle part and the identified auxiliary vehicle parts in the vehicle service center inventory. The processor 122 may generate an order form for the predicted vehicle part and the identified auxiliary vehicle parts when a response from the computing system 110 indicates that such parts are not available in the vehicle service center inventory, as shown by a block 308 in FIG. 3. In some aspects, the order form may include the part numbers associated with the predicted vehicle part and the identified auxiliary vehicle parts.

Responsive to generating the order form, the processor 122 may check the vehicle repair appointment time/schedule (as shown by a block 310 in FIG. 3) and transmit the order form to the computing system 116 a predefined time duration (e.g., 2-5 days) before the vehicle repair appointment, which is updated if the appointment is rescheduled. Responsive to receiving the order form from the processor 122, the vehicle part supplier 112 may ship the vehicle parts to the vehicle service center 106, as shown by a block 312 in FIG. 3.

The processor 122 transmits the order form to the computing system 116 a predefined time duration before the vehicle repair appointment so that the vehicle part supplier 112 has enough time to ship the predicted vehicle part and the identified auxiliary vehicle parts to the vehicle service center 106 and these vehicle parts arrive at the vehicle service center 106 before or at the vehicle repair appointment time. In this manner, when the vehicle 102 arrives at the vehicle service center 106 for repair, the vehicle service center 106 may already have the vehicle parts that may need replacement in the vehicle 102, and hence the vehicle waiting time at the vehicle service center 106 may be considerably reduced. This significantly enhances user convenience and experience of getting the vehicle 102 serviced/repaired and ensures that the vehicle 102 becomes operable for the user 104 within a short time duration.

The vehicle 102 and the system 114 implement and/or perform operations, as described here in the present disclosure, in accordance with the owner manual and safety guidelines. In addition, any action taken by the user 104 should comply with all the rules specific to the location and operation of the vehicle 102 (e.g., Federal, state, country, city, etc.). The notifications/recommendations, as provided by the vehicle 102 or the system 114, should be treated as suggestions and only followed according to any rules specific to the location and operation of the vehicle 102.

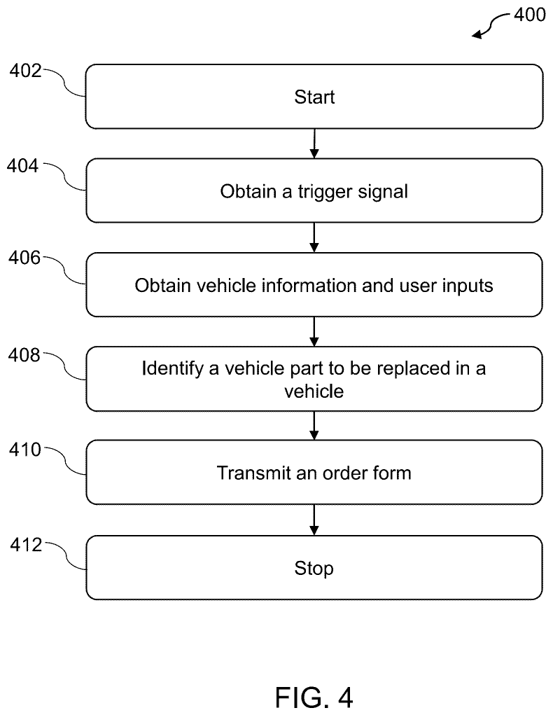

FIG. 4 depicts a flow diagram of an example vehicle repair intelligence method 400 in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include obtaining, by the processor 122, the trigger signal from the computing system 110. As described above, the processor 122 may obtain the trigger signal from the computing system 110 when the user 104 schedules the vehicle repair appointment at the vehicle service center 106.

At step 406, the method 400 may include obtaining, by the processor 122, the vehicle information (e.g., the vehicle details and the DTCs) and the user inputs/comments associated with the vehicle repair, responsive to obtaining the trigger signal. At step 408, the method 400 may include identifying, by the processor 122, one or more vehicle parts to be replaced in the vehicle 102 based on the vehicle information and the user inputs by executing instructions stored in the trained machine model 130. At step 410, the method 400 may include transmitting, by the processor 122, the order form associated with the vehicle part(s) to the vehicle part supplier 112 (or the computing system 116) to ship the vehicle part(s) to the vehicle service center 106.

The method 400 may end at step 412.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle repair intelligence system comprising:
a transceiver configured to receive a vehicle information and user inputs associated with a repair of a vehicle;
a memory configured to store a trained machine model, wherein the trained machine model is trained using a training data that comprises a mapping between vehicle information and user inputs associated with a plurality of vehicles that have historically availed repair services and vehicle part information associated with a plurality of vehicle parts that were replaced in the plurality of vehicles during repair services; and
a processor configured to:
obtain a trigger signal;
obtain the vehicle information and the user inputs associated with the repair of the vehicle responsive to obtaining the trigger signal;
identify a vehicle part to be replaced in the vehicle based on the vehicle information and the user inputs by executing instructions stored in the trained machine model; and
transmit an order form associated with the vehicle part to a vehicle part supplier to ship the vehicle part to a vehicle service center.

2. The vehicle repair intelligence system of claim 1, wherein the vehicle information comprises diagnostic trouble codes (DTCs) associated with the vehicle for a predefined historical time duration.

3. The vehicle repair intelligence system of claim 2, wherein the vehicle information further comprises one or more of: a vehicle model, a model year, a time in service, an engine type, a transmission type, or a mileage.

4. The vehicle repair intelligence system of claim 1, wherein the transceiver receives the vehicle information from the vehicle or a server.

5. The vehicle repair intelligence system of claim 1, wherein the transceiver receives the user inputs from a computing system associated with the vehicle service center.

6. The vehicle repair intelligence system of claim 5, wherein the transceiver is further configured to receive the trigger signal from the computing system associated with the vehicle service center.

7. The vehicle repair intelligence system of claim 1, wherein the transceiver receives the user inputs from a user device.

8. The vehicle repair intelligence system of claim 1, wherein the processor obtains the trigger signal when a user associated with the vehicle schedules a vehicle repair appointment with the vehicle service center.

9. The vehicle repair intelligence system of claim 8, wherein the processor is further configured to:
generate the order form responsive to identifying the vehicle part; and
transmit the order form a predefined time duration before the vehicle repair appointment.

10. The vehicle repair intelligence system of claim 8, wherein the user inputs comprise a transcript of a conversation between the user and an operator associated with the vehicle service center.

11. The vehicle repair intelligence system of claim 1, wherein the processor is further configured to:
transmit a query to a computing system associated with the vehicle service center enquiring an availability status of the vehicle part at the vehicle service center, responsive to identifying the vehicle part;
obtain a response from the computing system indicating that the vehicle part is not available at the vehicle service center, responsive to transmitting the query; and
transmit the order form to the vehicle part supplier responsive to obtaining the response.

12. The vehicle repair intelligence system of claim 1, wherein the processor is further configured to:
determine one or more auxiliary vehicle parts needed to repair the vehicle based on the vehicle information, responsive to identifying the vehicle part; and
transmit the order form associated with the one or more auxiliary vehicle parts to the vehicle part supplier to ship the one or more auxiliary vehicle parts to the vehicle service center.

13. The vehicle repair intelligence system of claim 1, wherein the order form comprises a part number of the vehicle part.

14. A vehicle repair intelligence method comprising:
obtaining, by a processor, a trigger signal;
obtaining, by the processor, a vehicle information and user inputs associated with a repair of a vehicle responsive to obtaining the trigger signal;
identifying, by the processor, a vehicle part to be replaced in the vehicle based on the vehicle information and the user inputs by executing instructions stored in a trained machine model, wherein the trained machine model is trained using a training data that comprises a mapping between vehicle information and user inputs associated with a plurality of vehicles that have historically availed repair services and vehicle part information associated with a plurality of vehicle parts that were replaced in the plurality of vehicles during repair services; and
transmitting, by the processor, an order form associated with the vehicle part to a vehicle part supplier to ship the vehicle part to a vehicle service center.

15. The vehicle repair intelligence method of claim 14, wherein the vehicle information comprises diagnostic trouble codes (DTCs) associated with the vehicle for a predefined historical time duration.

16. The vehicle repair intelligence method of claim 15, wherein the vehicle information further comprises one or more of: a vehicle model, a model year, a time in service, an engine type, a transmission type, or a mileage.

17. The vehicle repair intelligence method of claim 14, wherein obtaining the trigger signal comprises obtaining the trigger signal when a user associated with the vehicle schedules a vehicle repair appointment with the vehicle service center.

18. The vehicle repair intelligence method of claim 17 further comprising:
generating the order form responsive to identifying the vehicle part; and
transmitting the order form a predefined time duration before the vehicle repair appointment.

19. The vehicle repair intelligence method of claim 14 further comprising:
transmitting a query to a computing system associated with the vehicle service center enquiring an availability status of the vehicle part at the vehicle service center, responsive to identifying the vehicle part;
obtaining a response from the computing system indicating that the vehicle part is not available at the vehicle service center, responsive to transmitting the query; and
transmitting the order form to the vehicle part supplier responsive to obtaining the response.

20. A non-transitory computer-readable storage medium having instructions stored thereupon which, when executed by a processor, cause the processor to:
obtain a trigger signal;
obtain a vehicle information and user inputs associated with a repair of a vehicle responsive to obtaining the trigger signal;
identify a vehicle part to be replaced in the vehicle based on the vehicle information and the user inputs by executing instructions stored in a trained machine model, wherein the trained machine model is trained using a training data that comprises a mapping between vehicle information and user inputs associated with a plurality of vehicles that have historically availed repair services and vehicle part information associated with a plurality of vehicle parts that were replaced in the plurality of vehicles during repair services; and
transmit an order form associated with the vehicle part to a vehicle part supplier to ship the vehicle part to a vehicle service center.
